(19) United States
(12) Patent Application Publication
(10) Pub. No.: US 2026/0309434 A1
(43) Pub. Date: Oct. 8, 2026

(54) HEAT EXCHANGER

(71) Applicant: FUTABA INDUSTRIAL CO., LTD., Okazaki-shi (JP)

(72) Inventor: Hiroki YAMAGUCHI, Okazaki-shi (JP)

(21) Appl. No.: 19/573,253

(22) Filed: Mar. 20, 2026

(30) Foreign Application Priority Data
Apr. 2, 2025 (JP) 2025-061181

(51) Int. Cl. F28F 3/12; F28D 21/00

(52) U.S. Cl. CPC F28F 3/12; F28D 2021/0028; F28D 2021/008

(57) ABSTRACT

A heat exchanger used for a battery in a vehicle includes a flat body part and a flow passage for a heat exchange medium inside the body part. The body part includes two side portions arranged with a lengthwise centerline therebetween. The flow passage includes first and second port flow passages and two intermediate flow passages. The intermediate flow passages are provided in the respective side portions and each extend from the first port flow passage to second port flow passage. In each intermediate flow passage, lengthwise segments, end transverse segments, and intermediate transverse segments are arranged to extend, without branching, from the first port flow passage to the second port flow passage.

### CROSS-REFERENCE TO RELATED APPLICATIONS

This application claims the benefit of Japanese Patent Application No. 2025-061181 filed on Apr. 2, 2025 with the Japan Patent Office, the entire disclosure of which is incorporated herein by reference.

### BACKGROUND

The present disclosure relates to a heat exchanger for a battery mounted in a vehicle.

In a technique disclosed in Japanese Unexamined Patent Application Publication No. 2018-163741, two or more battery modules that house two or more battery cells stacked longitudinally are arranged in a state of being aligned longitudinally on top of a flat-shaped cooler. The cooler is provided with two or more flow conditioning passages extending longitudinally. Coolant flows through each of the flow conditioning passages longitudinally from a first end to a second end, thereby cooling the battery cells.

### SUMMARY

However, in the cooler of Japanese Unexamined Patent Application Publication No. 2018-163741, each flow conditioning passage extends longitudinally in a straight line. As a result, each flow conditioning passage may cause a significant difference in temperatures in the coolant between an upstream end and a downstream end of the flow conditioning passage in a flow direction of the coolant, potentially resulting in variations in cooling performance.

In one aspect of the present disclosure, it is desirable to induce uniformity of heat exchange performance of a heat exchanger.

One aspect of the present disclosure is a heat exchanger used for a battery mounted in a vehicle, and the heat exchanger comprises a body part and a flow passage for a heat exchange medium. The body part has a flat shape extending along a lengthwise direction and a transverse direction perpendicular to the lengthwise direction. The flow passage is provided inside the body part. The body part includes two side portions arranged with a lengthwise centerline extending in the lengthwise direction therebetween. An odd number of reference lines equal to or greater than three are arranged in each of the two side portions such that the odd number of reference lines in one side portion of the two side portions and the odd number of reference lines in an other side portion of the two side portions are substantially line-symmetric with respect to the lengthwise centerline. The odd number of reference lines extend from respective first ends to respective second ends in the lengthwise direction and are aligned in the transverse direction. The odd number of reference lines in each of the two side portions are formed to be substantially line-symmetric with respect to a transverse centerline extending in the transverse direction. The odd number of reference lines in each of the two side portions includes an outer reference line located furthest on an outer side, and inner reference lines located on an inner side relative to the outer reference line. The outer side is referred to as an edge side of the body part in the transverse direction, and the inner side is referred to as a center side of the body part in the transverse direction. The flow passage includes first and second port flow passages each including an opening and two intermediate flow passages. The two intermediate flow passages each are provided in a corresponding one of the two side portions and extend from the first port flow passage to the second port flow passage. Each of the two intermediate flow passages includes lengthwise segments extending in the lengthwise direction, end transverse segments extending in the transverse direction at each of the first end and the second end, and intermediate transverse segments extending in the transverse direction at locations spaced apart from the first end and the second end. The lengthwise segments, the end transverse segments, and the intermediate transverse segments are arranged to extend, without branching, from the first port flow passage to the second port flow passage. The intermediate transverse segments each connect, to each other, respective ends, aligned in the transverse direction, of two of the lengthwise segments arranged on two different reference lines of the odd number of reference lines. The intermediate transverse segments in the one side portion are arranged on a first end side relative to the transverse centerline, and the intermediate transverse segments in the other side portion are arranged on a second end side relative to the transverse centerline. At least one of the lengthwise segments is arranged on the outer reference line from the first end to the second end, and remaining ones of the lengthwise segments are arranged on corresponding ones of the inner reference lines from the first ends to the second ends.

According to the above-described configuration, in one of the two side portions, heat exchange is promoted in a region on the first end side relative to the transverse centerline, and in the other of the two side portions, the heat exchange is promoted in a region on the second end side relative to the transverse centerline. This can induce the heat exchange performance in the region on the first end side relative to the transverse center line and the heat exchange performance in the region on the second end side relative the transverse center line to be substantially the same level as the body part as a whole. Therefore, uniformity of the heat exchange performance of the heat exchanger can be induced.

In one aspect of the present disclosure, the end transverse segments and the intermediate transverse segments in the one side portion and the end transverse segments and the intermediate transverse segments in the other side portion may be arranged to be substantially point-symmetric about a flow passage center point. The flow passage center point may be an intersection of the lengthwise centerline and the transverse centerline.

According to the above-described configuration, regardless of which of the first and second port flow passages is an inlet for the heat exchange medium, substantially the same heat exchange performance can be achieved. Therefore, it is possible to mount the heat exchanger regardless of the orientation of the body part determining the locations of the first and second ports, and a workload for mounting the heat exchanger can be reduced.

In one aspect of the present disclosure, the lengthwise segments in each of the two side portions may include a lengthwise segment extending from the first port flow passage and a lengthwise segment extending from the second port flow passage.

According to the above-described configuration, the heat exchange performance can be improved.

In one aspect of the present disclosure, the intermediate transverse segments in each of the two side portions may include two intermediate transverse segments aligned in the lengthwise direction.

According to the above-described configuration, the heat exchange performance can be improved.

In one aspect of the present disclosure, the odd number of reference lines equal to or greater than three may be three reference lines.

According to the above-described configuration, the heat exchange performance can be improved.

### BRIEF DESCRIPTION OF THE DRAWINGS

An example embodiment of the present disclosure will be described hereinafter with reference to the accompanying drawings, in which:

FIG. 1A is a perspective view of a heat exchanger in which two or more battery cells are arranged;

FIG. 1B is a cross-sectional view taken along a line IB-IB in FIG. 1A; FIG. 1C is a cross-sectional view of a modified example of the heat exchanger taken along a line IB-IB in FIG. 1A;

FIG. 2A is a perspective view of a lower member when viewed from above; FIG. 2B is a perspective view of the lower member when viewed from below;

FIG. 3 is a bottom view of the heat exchanger;

FIG. 4A is an explanatory diagram showing of an intermediate flow passage of a specific example 1;

FIG. 4B is an explanatory diagram showing an intermediate flow passage of the specific example 1;

FIG. 4C is an explanatory diagram showing an intermediate flow passage of the specific example 1;

FIG. 5A is an explanatory diagram showing an intermediate flow passage of a specific example 2;

FIG. 5B is an explanatory diagram showing an intermediate flow passage of a specific example 3;

FIG. 6A is a bottom view of a modified example of the heat exchanger; and

FIG. 6B is a bottom view of a modified example of the heat exchanger.

### DETAILED DESCRIPTION OF EXEMPLARY EMBODIMENTS

### 1. Overview

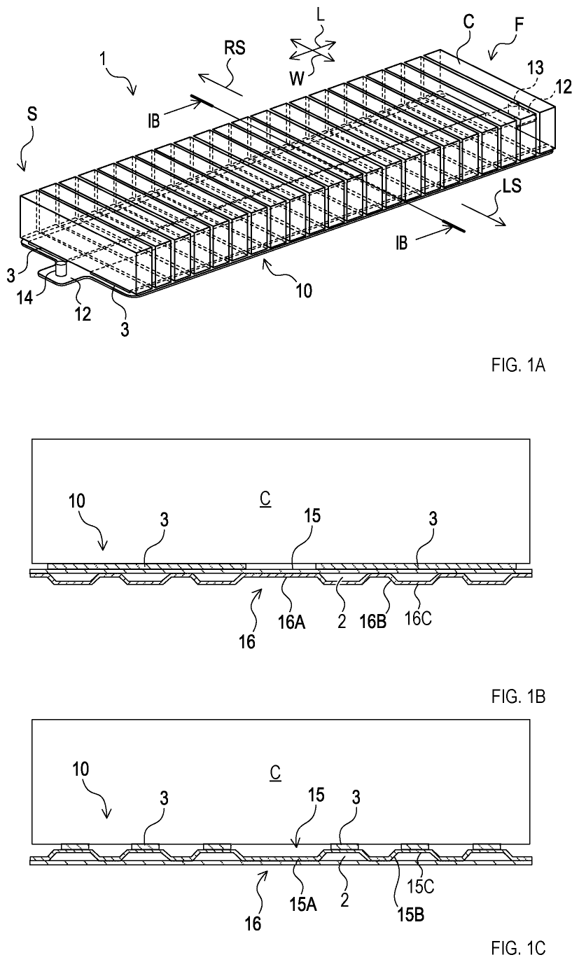

A heat exchanger 1 of the present embodiment is mounted in a vehicle and configured to cool or heat a battery of the vehicle (see FIGS. 1A to 1C). The vehicle may be, for example, a motor-driven vehicle, such as an electric vehicle, a plug-in hybrid vehicle, a hybrid vehicle, or the like. In this case, the heat exchanger 1 may cool or heat the battery that supplies power to the motor.

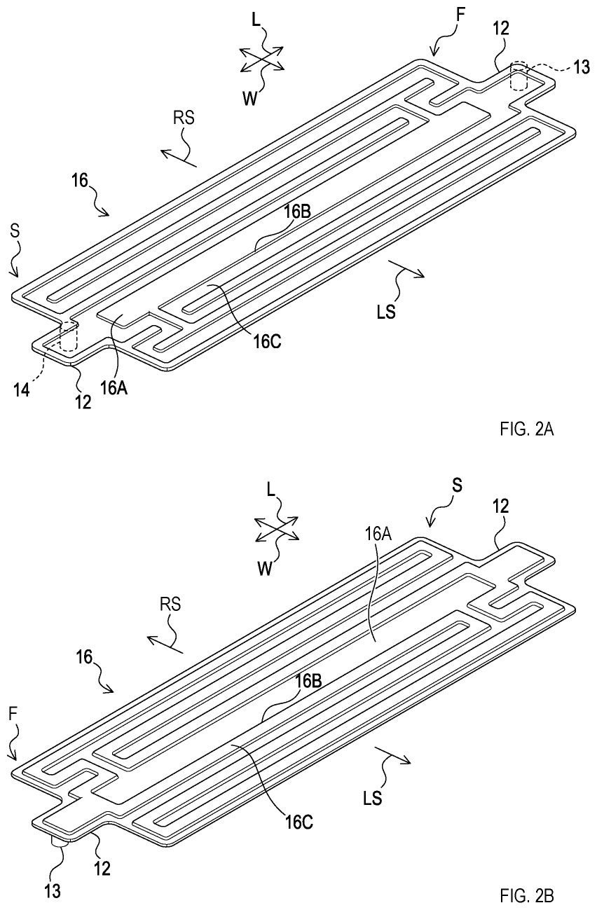

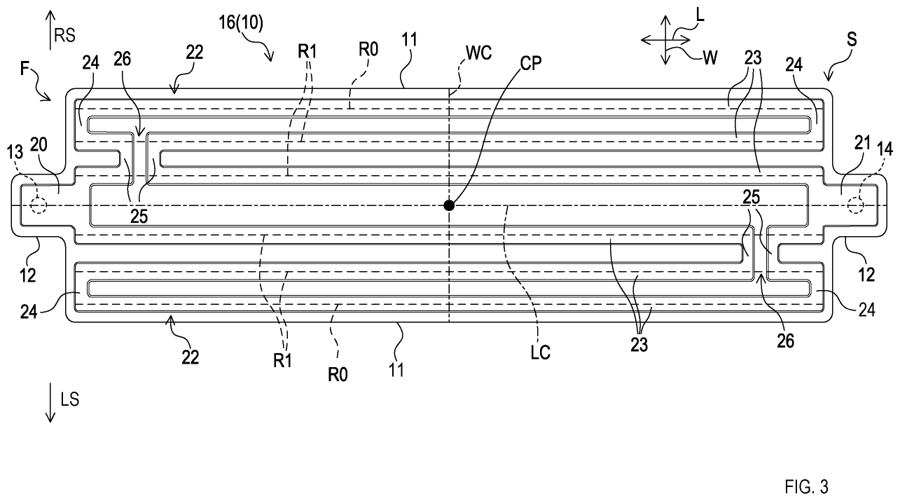

The heat exchanger 1 has a flat shape extending in a lengthwise direction L and a transverse direction W perpendicular to the lengthwise direction L (see FIGS. 2A to 3). The battery has a flat shape (e.g., rectangular shape) and includes two or more battery cells C stacked in the lengthwise direction L. Each battery cell C is arranged in a state in which its end face extending longitudinally is in contact with the heat exchanger 1 via a heat conductive member 3. However, an arrangement mode of the two or more battery cells C is not limited to this and may be determined as appropriate.

As an example, the heat exchanger 1 is mounted in the vehicle in a state of being disposed horizontally, and each battery cell C is arranged on an upper surface of the heat exchanger 1. However, the present disclosure is not limited thereto, and an orientation of the heat exchanger 1 mounted in the vehicle and positions and orientations of the two or more battery cells C arranged on the heat exchanger 1 may be determined as appropriate.

### 2. Configuration of Heat Exchanger

The heat exchanger 1 comprises a body part 10, a first port 13, and a second port 14 (see FIGS. 1A to 3).

### Body Part

The body part 10 has a flat shape that extends along the lengthwise direction L and the transverse direction W (see FIG. 1A, and 2A to 3). The body part 10 has an elongated shape extending along the lengthwise direction L and, as an example, is substantially rectangular when viewed in plan.

The body part 10 includes two protrusions 12 that protrude from a first end F and a second end S of the body part 10 in the lengthwise direction L. Each protrusion 12 has a substantially rectangular flat shape and is located centrally in the transverse direction W.

A virtual line that extends in the lengthwise direction L through the center of the body part 10 in the transverse direction W is referred to as a lengthwise centerline LC, and a virtual line extending in the transverse direction W through the center of the body part 10 in the lengthwise direction L is referred to as a transverse centerline WC. An intersection of the lengthwise centerline LC and the transverse centerline WC is referred to as a flow passage center point CP. Respective portions of the body part 10 located on a right side RS and a left side LS with respect to the lengthwise centerline LC are referred to as side portions 11.

The body part 10 is formed by a stack of an upper member 15 on a lower member 16, which are plate-shaped members, and a flow passage 2 for a heat exchange medium, for example, cooling water and the like is formed between the upper member 15 and the lower member 16.

Specifically, the upper member 15 is a flat portion. On the other hand, the lower member 16 is joined to a lower surface of the upper member 15 and provided with a contact portion 16A, a side wall 16B protruding downward from the contact portion 16A, and a bottom portion 16C extending from a lower end of the side wall 16B.

The contact portion 16A is in contact with the upper member 15 and, as an example, the contact portion 16A is welded to the upper member 15. The contact portion 16A and the bottom portion 16C are arranged substantially parallel to each other, and the side wall 16B is a step-shaped portion connecting these portions to each other. A flat space is formed between the upper member 15, and the side walls 16B and the bottom portion 16C, and the flow passage 2 is formed by the flat space.

The heat conductive members 3 are arranged to extend in the lengthwise direction L on an upper surface of a portion, of the upper member 15, that forms each side portion 11, and the two or more battery cells C are arranged on an upper side of the heat conductive member 3 on the side portion 11 (see FIGS. 1A and 1B). The heat conductive member 3 is, for example, clay-like and is in close contact with the upper surface of the upper member 15 and outer surfaces of the battery cells even when these surfaces are uneven. As a result, the provision of the heat conductive members 3 improves heat transfer between the body part 10 and each battery cell C.

It is noted that the present disclosure is not limited thereto, and, for example, the body part 10 may be formed by joining the lower member 16 having a flat plate shape to the upper member 15 including the contact portion 15A, the side wall 15B, and the bottom portion 15C, which are described above (see FIG. 1C). The heat conductive members 3 may be provided on the bottom portion 15C of the upper member 15, and the battery cells C may be arranged on the heat conductive members 3. Alternatively, for example, the upper member 15 and each battery cell C may be in direct contact with each other, without the heat conductive member 3.

### First and Second Ports

The first and second ports 13 and 14 are provided in the protrusions 12 located at respective opposite ends of the body part 10 in the lengthwise direction L (see FIGS. 1A and 2A to 3). The first and second ports 13 and 14 each form an inlet to or an outlet from the flow passage 2 for the heat exchange medium. Each of the first and second ports 13 and 14 may be either an inlet or an outlet, as appropriate. As an example, the first and second ports 13 and 14 are tubular portions provided on an upper surface of the body part 10 to protrude upward, and each of the first and second ports 13 and 14 has an open upper end. It is noted that the configurations of the first and second ports 13 and 14 are not limited to the above-described ones and may be determined as appropriate.

### 3. Flow Passage

### (1) Overview

The flow passage 2 includes a first port flow passage 20, a second port flow passage 21, and two intermediate flow passages 22 (see FIGS. 1B to 3).

The first and second port flow passages 20 and 21 are provided in the respective protrusions 12 at the first end F and the second end S of the body part 10. The first and second port flow passages 20 and 21 are respectively continuous with the first and second ports 13 and 14.

Each intermediate flow passage 22 is provided in a corresponding one of the side portions 11 of the body part 10 and is a single flow passage extending, without branching, from the first port flow passage 20 to the second port flow passage 21.

### (2) Reference Line

As shown in FIG. 3, an odd number of reference lines R0 and R1 equal to or greater than three are arranged in each of the side portions 11 of the body part 10 such that the odd number of reference lines R0 and R1 in one of the side portions 11 and the odd number of reference lines R0 and R1 in the other of the side portions 11 are substantially line-symmetric with respect to the lengthwise centerline LC. The odd number of reference lines R0 and R1 extend along the lengthwise direction L from their first ends to their second ends and are aligned in the transverse direction W. It is noted that the first ends of the reference lines R0 and R1 are located near the first end F of the body part 10, and the second ends of the reference lines R0 and R1 are located near the second end S of the body part 10. In each of the two side portions 11, the same number of reference lines R0 and the same number of reference lines R1 are provided, and the reference lines R0 and R1 in the two side portions 11 are formed to be substantially line-symmetric with respect to the transverse centerline WC. In the two side portions 11, the reference lines R0 and the reference lines R1 have the same lengths and are spaced at certain intervals from each other, and the first ends of these reference lines are aligned in the transverse direction W, and also, the second ends of these reference lines are aligned in the transverse direction W.

As the reference lines in each side portion 11, an outer reference line R0 and two or more inner reference lines R1 are provided. The outer reference line R0 is located furthest on the outer side, and the two or more inner reference lines R1 are located on an inner side relative to the outer reference line R0. The “outer side” is an edge side of the body part 10 in the transverse direction W, and the “inner side” is a center side of the body part 10 in the transverse direction W.

In FIG. 3, as an example, each side portion 11 is provided with the three reference lines. It is noted that the number of the reference lines in the side portion 11 is not limited thereto and may be determined as appropriate.

### (3) Intermediate Flow Passage

Each intermediate flow passage 22 has a substantially constant width and includes two or more lengthwise segments 23, two or more end transverse segments 24, and two or more intermediate transverse segments 25 (see FIGS. 3 to 5B).

The two or more lengthwise segments 23 each extend in the lengthwise direction L and are arranged on the reference lines R0 and R1. More specifically, on the outer reference line R0, a single lengthwise segment 23 extending from the first end to the second end is arranged, or the two or more lengthwise segments 23 spaced at one or more specific intervals from the first end to the second end are arranged. On each of the inner reference lines R1, the two or more lengthwise segments 23 spaced at one or more specific intervals from the first end to the second end are arranged.

In contrast, the two or more end transverse segments 24 and the two or more intermediate transverse segments 25 extend in the transverse direction W. Each end transverse segment 24 is located at the first ends or the second ends of two of the two or more reference lines, and connects, to each other, the respective ends of two lengthwise segments 23 on different reference lines, or connects, to each other, the first port flow passage 20 or the second port flow passage 21 and an end of a corresponding one of the lengthwise segments 23. Each intermediate transverse segment 25 is arranged at a location apart from the first ends and the second ends of the reference lines, and connects, to each other, respective ends, arranged on the first end F side and aligned in the transverse direction W, of two lengthwise segments 23 on different reference lines, or respective ends, arranged on the second end S side and aligned in the transverse direction W, of two lengthwise segments 23 on different reference lines.

The two or more lengthwise segments 23, the two or more end transverse segments 24, and the two or more intermediate transverse segments 25 in each intermediate flow passage 22 are arranged such that the intermediate flow passage 22 extends, without branching, from the first port flow passage 20 to the second port flow passage 21. The shape of each intermediate flow passage 22 may be determined as appropriate by adjusting the number, lengths, and/or positions of the two or more lengthwise segments 23, the two or more end transverse segments 24, and the two or more intermediate transverse segments 25.

All the intermediate transverse segments 25 in the intermediate flow passage 22 in the side portion 11 on the right side RS are located on the first end F side relative to the transverse centerline WC, and all the intermediate transverse segments 25 in the intermediate flow passage 22 in the side portion 11 on the left side LS are located on the second end S side relative to the transverse centerline WC.

### Specific Example 1 of Intermediate Flow Passage

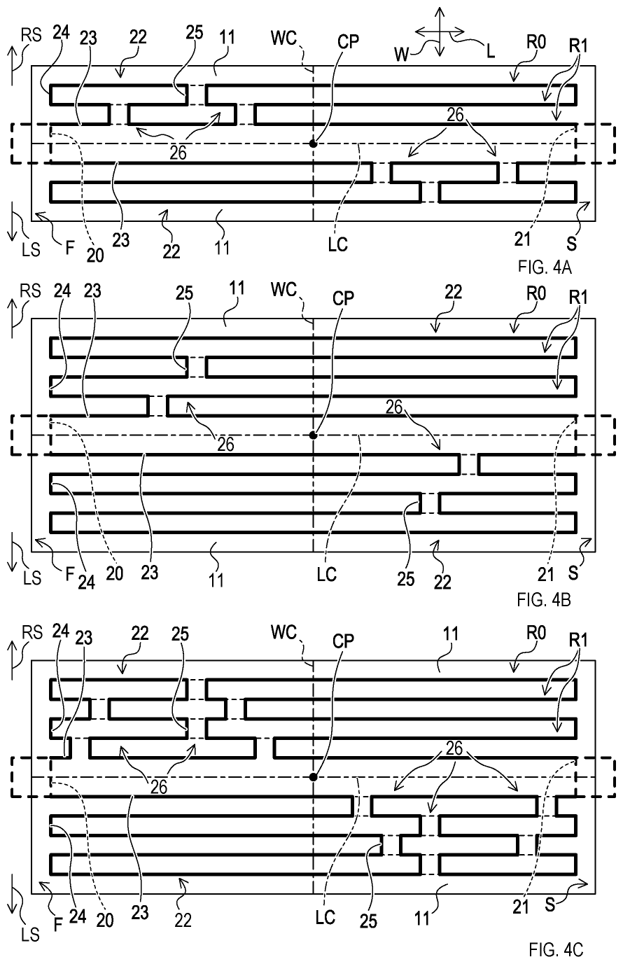

In each intermediate flow passage 22 of the specific example 1, on the innermost inner reference line R1, a lengthwise segment 23 extending from the first end of the innermost inner reference line R1 (in other words, from the first port flow passage 20) and a lengthwise segment 23 extending from the second end of the innermost inner reference line R1 (in other words, from the second port flow passage 21) (see FIGS. 3 to 4C) are provided. The end transverse segments 24 are located at the first end and the second end of the reference lines and each connect, to each other, the respective ends of two lengthwise segments 23 on adjacent reference lines. Two or more lengthwise segments 23 on a single reference line are arranged such that their respective ends are adjacent to each other.

Each intermediate transverse segment 25 connects, to each other, respective ends located on the first end F side and aligned in the transverse direction W, of two lengthwise segments 23 on adjacent reference lines, or connects, to each other, respective ends of two lengthwise segments 23 located on the second end S side and aligned in the transverse direction W, of two lengthwise segments 23 on the adjacent reference lines. The intermediate transverse segment 25 connecting the ends on the first end F side and the intermediate transverse segment 25 connecting the ends on the second end S side are arranged adjacent to each other in the lengthwise direction L. Hereinafter, the two adjacent intermediate transverse segments 25 are also referred to as a turn-back portion 26.

The intermediate transverse segments 25 and the end transverse segments 24 of the intermediate flow passage 22 on the right side RS and the intermediate transverse segments 25 and the end transverse segments 24 of the intermediate flow passage 22 on the left side LS are arranged so as to be substantially point-symmetric about the flow passage center point CP. As an example, these intermediate flow passages 22 have shapes that are substantially point-symmetric about the flow passage center point CP. However, the arrangement of each intermediate transverse segment 25 is not limited to such point symmetry and may be determined as appropriate. For example, the number of turn-back portions 26 in each intermediate flow passage 22 may be different.

In FIGS. 3 and 4A, as an example, the three reference lines R0 and R1 are provided in each side portion 11. In FIGS. 3 and 4A, one or three turn-back portions 26 are respectively provided in each intermediate flow passage 22 as an example. In FIGS. 4B and 4C, the five reference lines R0 and R1 are provided in each side portion 11 as an example. In FIGS. 4B and 4C, the two or six turn-back portions 26 are respectively provided in each intermediate flow passage 22 as an example. However, the number of the reference lines and the number of the turn-back portions 26 may be determined as appropriate.

### Specific Example 2 of Intermediate Flow Passage

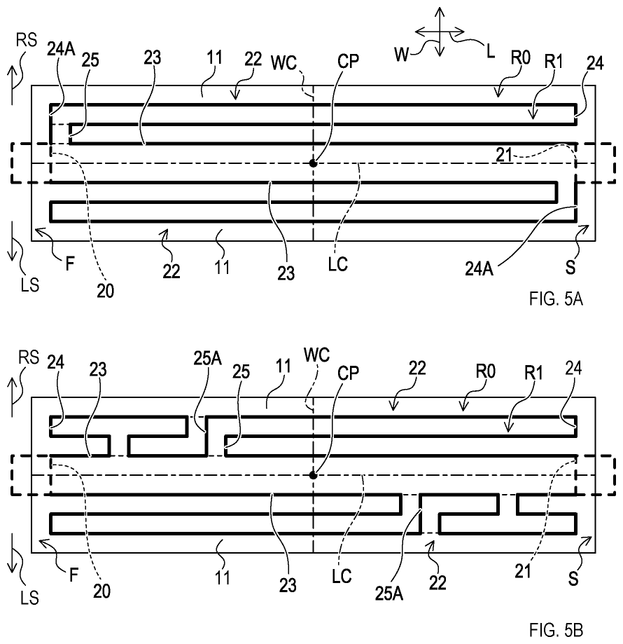

In the specific example 2, the intermediate flow passage 22 in the side portion 11 on the right side RS is provided with an end transverse segment extending from the first end of the innermost inner reference line R1 (in other words, from the first port flow passage 20) (see FIG. 5A). The intermediate flow passage 22 in the side portion 11 on the left side LS is provided with an end transverse segment extending from the second end of the innermost inner reference line R1 (in other words, from the second port flow passage 21). The specific example 2 differs from the specific example 1 in these points.

Hereinafter, these end transverse segments are referred to as specific end transverse segments 24A. Each of the specific end transverse segments 24A extends across the inner reference line R1 to the end of the lengthwise segment 23 on the outer reference line R0, and a corresponding one of the intermediate transverse segments 25 is arranged adjacent thereto.

In FIG. 5A, as an example, the three reference lines R0 and R1 are provided in each side portion 11. However, five or more reference lines may be provided in each side portion 11. In this case, the specific end transverse segment 24A may extend to the end of the lengthwise segment 23 on the outer reference line R0 or may extend to the end of the lengthwise segment 23 on the inner reference line R1.

### Specific Example 3 of Intermediate Flow Passage

Each intermediate flow passage 22 of the specific example 3 differs from the specific examples 1 and 2 in that an intermediate transverse segment 25 extending across the inner reference line R1 (hereinafter, a specific intermediate transverse segment 25A) is provided (see FIG. 5B).

In FIG. 5B, as an example, three reference lines R0 and R1 are provided in each side portion 11, and one specific intermediate transverse segment 25A is provided in each intermediate flow passage 22. However, five or more reference lines may be provided in each side portion 11, and two or more specific intermediate transverse segments 25A may be provided in each intermediate flow passage 22. Further, the specific end transverse segment 24A and the specific intermediate transverse segment 25A may be provided in each intermediate flow passage 22 of the specific example 3.

### (4) Modified Examples of Port Flow Passage

In the above-described embodiments, the first and second port flow passages 20 and 21 are respectively provided in the protrusions 12 at the first end F and the second end S of the body part 10, and the protrusions 12 are respectively located in a center portion of the body part 10 in the transverse direction W at the first end F and the second end S of the body part 10.

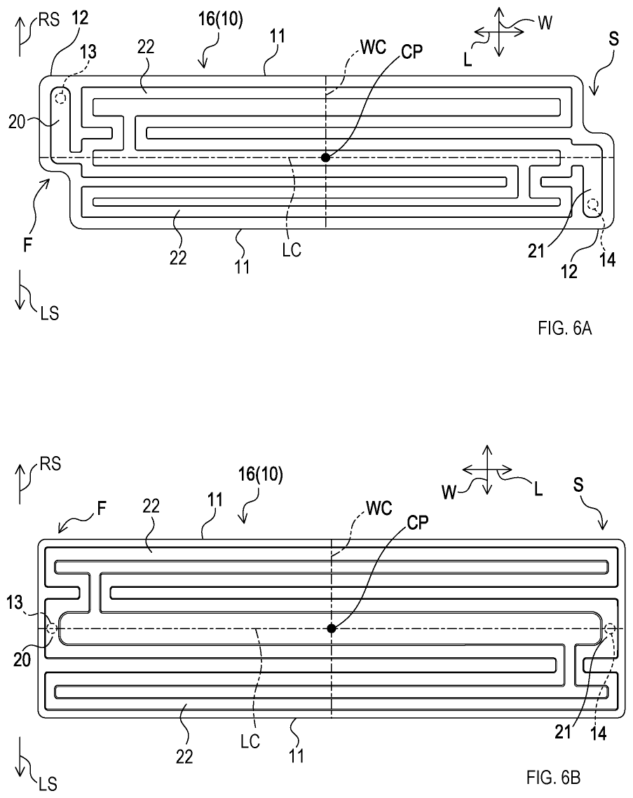

However, one of the protrusions 12 may be located in a portion of the body part 10 on the right side RS at the first end F, and the other of the protrusions 12 may be located in a portion of the body part 10 on the left side LS at the second end S. The first and second port flow passages 20 and 21 may be arranged within these protrusions 12 (see FIG. 6A). The first port 13 may be arranged near an end of the protrusion 12 on the right side RS at the first end F, and the second port 14 may be arranged near an end of the protrusion 12 on the left side LS at the second end S.

In an alternative configuration, the body part 10 may be provided without the protrusion 12 (see FIG. 6B). In respective center portions of the body part 10 in the transverse direction W at the first end F and the second end S, the first and second port flow passages 20 and 21 and the first and second ports 13 and 14 may be arranged.

### 4. Effects

(1) Assuming that each side portion 11 of the body part 10 is provided with two or more flow passages for a heat exchange medium that extend in the lengthwise direction L from the first port flow passage to the second port flow passage. In this case, if the first port 13 is an inlet for the heat exchange medium, each flow passage includes a high zone having a high heat exchange performance, a middle zone having a medium heat exchange performance, and a low zone having a low heat exchange performance that are aligned in the lengthwise direction L. As a result, the battery cells C located near the first port 13 are in contact only with a portion of the body part 10 having the high heat exchange performance, and the battery cells C located near the second port 14 are in contact only with a portion of the body part 10 having the low heat exchange performance. Therefore, there is a concern that temperature differences of the battery cells C become significant.

On the other hand, according to the above-described embodiments, the two or more intermediate transverse segments 25 in the intermediate flow passage 22 in the side portion 11 on the right side RS of the body part 10 are located in a region (hereinafter, first region) on the first end F side relative to the transverse centerline WC. Similarly, the two or more intermediate transverse segments 25 in the intermediate flow passage 22 in the side portion 11 on the left side LS are located in a region (hereinafter, second region) on the second end S side relative to the transverse centerline WC.

Thus, in the side portion 11 on the right side RS, an average distance (hereinafter, average port distance) from the first port 13 to any point in a portion of the intermediate flow passage 22 located in the first region is induced to be shorter. In other words, in the side portion 11 on the right side RS, the high zone of the intermediate flow passage 22 is induced to be located in the first region. Thus, the heat exchange in the first region is promoted. In addition, it is possible to induce the high zone, the middle zone, and the low zone in each intermediate flow passages 22 to be aligned in the transverse direction W, rather than merely in the lengthwise direction L. This makes it possible to inhibit unevenness in heat exchange performance.

On the other hand, in the side portion 11 on the left side LS, the average port distance to any point in a portion of the intermediate flow passage 22 in the second region is induced to be shorter. In other words, in the side portion 11 on the left side LS, the high zone of the intermediate flow passage 22 can be induced to be located not only in the first region, but also in the second region, and thereby the heat exchange in the second region is promoted. In addition, the middle zone and the low zone of the intermediate flow passage 22 can be induced to be located in the first region, and also the high zone, the middle zone, and the low zone can be induced to be aligned in the transverse direction W, rather than merely in the lengthwise direction L. This makes it possible to inhibit unevenness in heat exchange performance.

Accordingly, as an example, the battery cells C located near the first port 13 can be in contact with the portion of the side portion 11 on the right side RS having the high heat exchange performance and with the portion of the side portion 11 on the left side LS having the medium heat exchange performance. In addition, the battery cells C located near the second port 14 can be in contact with the portion of the side portion 11 on the right side RS having the medium heat exchange performance and with the portion of the side portion 11 on the left side LS having the low heat exchange performance. Therefore, the temperature differences among the battery cells C can be reduced, and thus degradation of the battery to be cooled by the heat exchanger 1 can be inhibited.

(2) The intermediate transverse segments 25 of the intermediate flow passage 22 in the side portion 11 on the right side RS and the intermediate transverse segments 25 of the intermediate flow passage 22 in the side portion 11 on the left side LS have shapes that are substantially point-symmetric about the flow passage center point CP. As a result, regardless of which of the first and second ports 13 and 14 is an inlet for the heat exchange medium, substantially the same heat exchange performance can be achieved. Therefore, it is possible to mount the heat exchanger 1 regardless of the orientation of the body part 10 determining the locations of the first and second ports 13 and 14, and a workload for mounting the heat exchanger 1 can be reduced.

(3) In each intermediate flow passage 22 of the specific example 1, the lengthwise segment 23 extending from the first end (in other words, from the first port flow passage 20) and the lengthwise segment 23 extending from the second end (in other words, from the second port flow passage 21) are provided on the respective innermost inner reference lines R1. According to a computer simulation, the provision of such lengthwise segments 23 improves heat exchange performance, as compared with a case in which the specific end transverse segments 24A are provided as in the specific example 2.

In addition, in the specific example 1, it is assumed that the three reference lines R0 and R1 are provided in each side portion 11 and that the single turn-back portion 26 is provided in each intermediate flow passage 22. In this case, results of the computer simulation demonstrated that the heat exchange performance can be induced to be more uniform by arranging the turn-back portion 26 of the intermediate flow passage 22 on the right side RS closer to the first end F and by arranging the turn-back portion 26 of the intermediate flow passage 22 on the left side LS closer to the second end S.

### 5. Other Embodiments

A function/functions that a single element in the above-described embodiments has may be implemented by two or more elements in a distributed manner, and a function/functions that two or more elements have may be implemented by a single element in an integrated manner. A portion of the configuration in the above-described embodiments may be omitted. At least a portion of the configuration in the above-described embodiments may be added to or replace the configuration in other embodiments.

1. A heat exchanger used for a battery mounted in a vehicle, the heat exchanger comprising:
a body part having a flat shape extending along a lengthwise direction and a transverse direction perpendicular to the lengthwise direction; and
a flow passage for a heat exchange medium, the flow passage being provided inside the body part,
the body part including two side portions arranged with a lengthwise centerline extending in the lengthwise direction therebetween,
an odd number of reference lines equal to or greater than three being arranged in each of the two side portions such that the odd number of reference lines in one side portion of the two side portions and the odd number of reference lines in an other side portion of the two side portions are substantially line-symmetric with respect to the lengthwise centerline, the odd number of reference lines extending from respective first ends to respective second ends in the lengthwise direction and being aligned in the transverse direction, the odd number of reference lines in each of the two side portions being formed to be substantially line-symmetric with respect to a transverse centerline extending in the transverse direction,
the odd number of reference lines in each of the two side portions including:
an outer reference line located furthest on an outer side, the outer side being referred to as an edge side of the body part in the transverse direction, and inner reference lines located on an inner side relative to the outer reference line, the inner side being referred to as a center side of the body part in the transverse direction,
the flow passage including:
first and second port flow passages each including an opening, and
two intermediate flow passages each being provided in a corresponding one of the two side portions and extending from the first port flow passage to the second port flow passage,
each of the two intermediate flow passages including lengthwise segments extending in the lengthwise direction, end transverse segments extending in the transverse direction at each of the first end and the second end, and intermediate transverse segments extending in the transverse direction at locations spaced apart from the first end and the second end,
the lengthwise segments, the end transverse segments, and the intermediate transverse segments being arranged to extend, without branching, from the first port flow passage to the second port flow passage,
the intermediate transverse segments each connecting, to each other, respective ends, aligned in the transverse direction, of two of the lengthwise segments arranged on two different reference lines of the odd number of reference lines,
the intermediate transverse segments in the one side portion being arranged on a first end side relative to the transverse centerline, and the intermediate transverse segments in the other side portion being arranged on a second end side relative to the transverse centerline, and
at least one of the lengthwise segments being arranged on the outer reference line from the first end to the second end, and remaining ones of the lengthwise segments being arranged on corresponding ones of the inner reference lines from the first ends to the second ends.

2. The heat exchanger according to claim 1, wherein
the end transverse segments and the intermediate transverse segments in the one side portion and the end transverse segments and the intermediate transverse segments in the other side portion are arranged to be substantially point-symmetric about a flow passage center point, the flow passage center point being an intersection of the lengthwise centerline and the transverse centerline.

3. The heat exchanger according to claim 1, wherein
the lengthwise segments in each of the two side portions include a lengthwise segment extending from the first port flow passage and a lengthwise segment extending from the second port flow passage.

4. The heat exchanger according to claim 1, wherein
the intermediate transverse segments in each of the two side portions include two intermediate transverse segments aligned in the lengthwise direction.

5. The heat exchanger according to claim 1, wherein
the odd number of reference lines equal to or greater than three are three reference lines.
